(19) United States
(12) Patent Application Publication
(10) Pub. No.: US 2025/0157182 A1
(43) Pub. Date: May 15, 2025

(54) VEHICLE DAMAGE IDENTIFICATION METHOD AND SYSTEM, ELECTRONIC DEVICE AND STORAGE MEDIUM

(71) Applicant: DATA ENLIGHTEN TECHNOLOGY (BEIJING) CO., LTD, Beijing (CN)

(72) Inventors: Kai ZHOU, Beijing (CN); Minglun CAI, Beijing (CN); Mingrui LIAO, Beijing (CN); Gengyu LIAO, Beijing (CN)

(21) Appl. No.: 19/022,838

(22) Filed: Jan. 15, 2025

Related U.S. Application Data
(63) Continuation of application No. PCT/CN2023/088277, filed on Apr. 14, 2023.

(30) Foreign Application Priority Data
Jul. 21, 2022 (CN) 202210864318.9

(51) Int. Cl. G06V 10/72; G06V 10/26; G06V 10/75; G06V 10/764; G06V 10/774

(52) U.S. Cl. CPC G06V 10/72; G06V 10/26; G06V 10/751; G06V 10/764; G06V 10/774; G06V 2201/08

(57) ABSTRACT

A vehicle damage identification method includes dividing the entire appearance of a target vehicle into N predetermined blocks; according to a preset image collection model, respectively performing image collection on each of the N blocks, so as to obtain N original images corresponding to the N blocks; performing vehicle part identification on each of the N original images, so as to obtain a vehicle part position identification result; according to a preset cutting model, cutting each of the N original images into M sub-images of a predetermined size; respectively performing damage identification on each of the N original images and the M sub-images corresponding thereto, so as to obtain a damage identification result. The method further includes fusing the vehicle part position identification result with the damage identification result, so as to obtain a vehicle part damage result of the target vehicle.

### CROSS-REFERENCE TO RELATED APPLICATIONS

This is a PCT Bypass continuation application claiming priority under 35 U.S.C. § 120 to International Application No. PCT/CN2023/088277 filed on Apr. 14, 2023, and claims priority under 35 U.S.C. § 119 to Chinese Patent Application No. 202210864318.9 filed on Jul. 21, 2022, the entire content of each is incorporated herein by reference.

### TECHNICAL FIELD

The presently disclosed subject matter relates to the field of artificial intelligence for the automotive aftermarket, and more particularly to a deep learning-based vehicle damage identification method and system, an electronic device, and a storage medium.

### BACKGROUND

At present, in the field of automotive aftermarket, the technology regarding the identification and loss assessment for damaged portions of a vehicle is mainly applied to, for example, a company or a third-party institution with identification or loss assessment. During loss assessment, the loss assessment personnel shoots and uploads the appearance picture of the damaged portion of the vehicle through a mobile phone, and then the system automatically identifies the damaged parts and the damage category, thereby improving the loss assessment claim efficiency of the small case or making an approximate loss assessment value for the visual damage. It can thus be seen that the existing technologies in the current automotive aftermarket are all to make a loss assessment on the visually visible damaged portion of the vehicle, and have a certain subjective judgment, and there is also ambiguity in the definition of the damage. Moreover, for the damage that cannot be easily determined and is not easily perceived, there is not yet a solution to realize a loss assessment process. For example, in the automobile rental industry, when a customer returns a rental vehicle to a rental company, some losses in the appearance of the vehicle cannot be easily determined by naked eyes and is not easily perceived. Therefore, for such losses, a new technical means needs to be provided to identify and assess such losses.

Furthermore, in the automobile damage identification in the prior art, in order to capture a fine damage, it may be desired and/or necessary to take a close-range photo and a long-distance photo at the same time. Among them, the close-range photo is used for detail identification, and the long-distance photo is used for vehicle body position identification. Although such image collection and identification process is accurate, users are required to take multiple photos, which affects use experience and time efficiency, and results in low efficiency.

### SUMMARY

In view of the above situation, the presently disclosed subject matter is proposed, and the objective of the presently disclosed subject matter is to provide a vehicle damage identification method and system, an electronic device, and a storage medium, which utilize an end-to-end standardized damage identification process to convert the vehicle damage identification from a subjective judgment to a scientific and objective judgment, thereby reducing the user's reliance on vehicle professional knowledge, providing wide versatility and compatibility, and improving the identification efficiency of minor vehicle damage identification. Moreover, by using a standardized image collection flow and an image pre-processing flow, the presently disclosed subject matter can reduce the number of times of image collection and speed up the image collection process without affecting the accuracy of damage identification, thereby increasing the speed of the entire damage identification and improving the efficiency of damage identification.

According to the first aspect of the presently disclosed subject matter, a vehicle damage identification method for performing damage identification on a target vehicle is provided. The method can include: dividing an entire appearance of the target vehicle into N predetermined blocks, N being a positive integer; respectively performing image collection on each of the N blocks according to a preset image collection model, so as to obtain N original images corresponding to the N blocks; performing vehicle part identification on each of the N original images, so as to obtain a vehicle part position identification result; cutting each of the N original images into M sub-images of a predetermined size according to a preset cutting model, M being a positive integer; respectively performing damage identification on each of the N original images and the M sub-images corresponding thereto, so as to obtain a damage identification result; and fusing the vehicle part position identification result with the damage identification result, so as to obtain a vehicle part damage result of the target vehicle.

According to this embodiment, the following technical effects can be obtained: through the standardized damage identification process, the vehicle damage identification is converted from a subjective judgment to a scientific and objective judgment, which reduces the user's reliance on vehicle professional knowledge, provides wide versatility and compatibility, and improves the identification efficiency of minor vehicle damage identification. In addition, by using a standardized image collection flow and an image pre-processing flow, the number of times of image collection can be reduced and the image collection process can be sped up without affecting the accuracy of damage identification, thereby increasing the speed of the entire damage identification and improving the efficiency of damage identification.

As an embodiment, the image collection model may include: respectively performing image collection on the N regions of the target vehicle at a preset shooting angle, so as to obtain the N original images with an aspect ratio of a:b.

According to this embodiment, the following technical effects can be obtained: the image collection can be performed at a predetermined shooting angle on each region that has been divided, so as to standardize the collected original images. Therefore, the number of times of image collection can be reduced and the image collection process can be sped up without affecting the accuracy of damage identification. In addition, it is also possible to reduce the influence of subjective shooting of the user on the original image, improve the application efficiency of image collection, and improve the vehicle parts coverage rate of the vehicle in the image, thereby improving the efficiency of damage identification.

As an embodiment, the cutting model may include: performing an a-equal division on the original image in a transverse direction and performing a b-equal division on the original image in a longitudinal direction in each of the N original images, so as to obtain a×b sub-images, wherein a×b=M.

According to this embodiment, the following technical effects can be obtained: a preset cutting model can be used to perform the standardized cutting processing on the obtained original image, so as to obtain square sub-images of the same size, so that the size of the cut image basically conforms to the size of the training image, which avoids problems that may be encountered in convolution, such as poor invariance implicit ability, and there is no need to perform a size adjustment, etc., so that the aspect ratio of the image will not be changed, and then all original features of the whole original image are saved.

As an embodiment, respectively performing damage identification on each of the N original images and the M sub-images corresponding thereto, so as to obtain a damage identification result may include: respectively performing damage identification on each of the N original images, so as to obtain an overall damage identification result for each of the original images; respectively performing damage identification on the M sub-images in each of the original images, so as to obtain a local damage identification result; performing a coordinate transformation on the local damage identification result according to a position of each of the M sub-images in its corresponding original image, so as to transform coordinates of the local damage identification result from the coordinates in the sub-image to the coordinates in the corresponding original image, thereby obtaining a transformed local damage identification result; and fusing the transformed local damage identification result with the overall damage identification result, so as to obtain the damage identification result.

According to this embodiment, the following technical effects can be obtained: damage identification can be performed on the original image and the sub-image respectively, thereby improving the precision and accuracy of the damage identification.

As an embodiment, the method may further include: outputting and displaying the vehicle part damage result.

According to this embodiment, the following technical effects can be obtained: the display result can be directly displayed to the user who took the photo, so that the user can obtain the display information of the vehicle damage results within a short time (basically controlled within 5 minutes) after taking the photo.

As an embodiment, dividing an entire appearance of the target vehicle into N predetermined blocks may include: dividing the entire appearance of the target vehicle into 14 blocks, the 14 blocks including: a front side upper portion, a front side lower portion, a left front portion, a right front portion, a left side front portion, a right side front portion, a left side middle portion, a right side middle portion, a left side rear portion, a right side rear portion, a left rear portion, a right rear portion, a rear side upper portion, and a rear side lower portion of the target vehicle.

According to this embodiment, the following technical effect can be obtained: through the above region division and the image collection of the above divided regions, the parts in each region can repeatedly appear in multiple collected images, so as to ensure that the damage can be detected in at least one or more images. Therefore, through the standardized division and image collection, it is possible to reduce the influence of subjective shooting of the user on the original image, improve the application efficiency of image collection, and improve the vehicle parts coverage rate of the vehicle in the image, thereby improving the efficiency of damage identification.

According to the second aspect of the presently disclosed subject matter, a vehicle damage identification apparatus for performing damage identification on a target vehicle is provided. The apparatus includes: a division module configured to divide an entire appearance of the target vehicle into N predetermined blocks, N being a positive integer; an original image collection module configured to respectively perform image collection on each of the N blocks according to a preset image collection model, so as to obtain N original images corresponding to the N blocks; a vehicle part position identification module configured to perform vehicle part identification on each of the N original images, so as to obtain a vehicle part position identification result; an original image cutting module configured to cut each of the N original images into M sub-images of a predetermined size according to a preset cutting model, M being a positive integer; a damage identification module configured to respectively perform damage identification on each of the N original images and the M sub-images corresponding thereto, so as to obtain a damage identification result; and a vehicle part damage fusion module configured to fuse the vehicle part position identification result with the damage identification result, so as to obtain a vehicle part damage result of the target vehicle.

As an embodiment, the image collection module may include: respectively performing image collection on N regions of the target vehicle at a preset shooting angle, so as to obtain the N original images with an aspect ratio of a:b.

As an embodiment, the cutting model may include: performing an a-equal division on the original image in a transverse direction and performing a b-equal division on the original image in a longitudinal direction in each of the N original images, so as to obtain a×b sub-images, wherein a×b=M.

As an embodiment, the damage identification module may include: an overall damage identification unit configured to respectively perform damage identification on each of the N original images, so as to obtain an overall damage identification result for each of the original images; a local damage identification unit configured to respectively perform damage identification on the M sub-images in each of the original images, so as to obtain a local damage identification result; a coordinate transformation unit configured to perform a coordinate transformation on the local damage identification result according to a position of each of the M sub-images in its corresponding original image, so as to transform coordinates of the local damage identification result from the coordinates in the sub-image to the coordinates in the corresponding original image, thereby obtaining a transformed local damage identification result; and a damage fusion unit configured to fuse the transformed local damage identification result with the overall damage identification result, so as to obtain the damage identification result.

As an embodiment, the apparatus may further include: a result output module, configured to output and display the vehicle part damage result.

As an embodiment, the division module is configured to divide the entire appearance of the target vehicle into 14 blocks, the 14 blocks including: a front side upper portion, a front side lower portion, a left front portion, a right front portion, a left side front portion, a right side front portion, a left side middle portion, a right side middle portion, a left side rear portion, a right side rear portion, a left rear portion, a right rear portion, a rear side upper portion, and a rear side lower portion of the target vehicle.

According to the above embodiments of the vehicle damage identification apparatus in the second aspect, the technical effects basically the same as those of the embodiments of the corresponding vehicle damage identification method can be obtained, which is no longer repeated here.

According to a third aspect of the presently disclosed subject matter, an electronic device is provided, the electronic device including: a memory that stores a computer program; a processor that executes the computer program to implement steps of the method according to the first aspect; and a camera device for performing image collection and a display device for display.

According to the electronic device of the third aspect, an end-to-end standardized damage identification process can be realized, and the vehicle damage identification can be converted from the subjective judgment to the scientific and objective judgment, which reduces the user's reliance on vehicle professional knowledge, and can reduce the number of times of image collection and speed up the image collection process without affecting the accuracy of damage identification, thereby increasing the speed of the entire damage identification, reducing the manpower time required by damage identification (which may be reduced to be within 5 minutes), and thereby reducing the training cost of the personnel.

According to the fourth aspect of the presently disclosed subject matter, a computer-readable storage medium is provided, wherein a computer program is stored in the medium, and the computer program, when executed by a processor, implements steps of the method according to the first aspect.

The technical solution of the presently disclosed subject matter will be further described in detail below with reference to the accompanying drawings and preferred embodiments of the presently disclosed subject matter, and the beneficial effects of the present intention will be further clarified.

### BRIEF DESCRIPTION OF THE DRAWINGS

The drawings described herein are used to provide a further understanding of the presently disclosed subject matter, and constitute a part of the presently disclosed subject matter, but the descriptions thereof are merely used to explain the presently disclosed subject matter, and do not constitute an improper limitation on the presently disclosed subject matter.

FIG. 1 is a schematic flowchart of a vehicle damage identification method according to a preferred embodiment of the presently disclosed subject matter;

FIG. 2 is a schematic flowchart of an example showing the damage identification steps of a vehicle damage identification method according to a preferred embodiment of the presently disclosed subject matter;

FIG. 3 is a schematic flowchart of a vehicle damage identification method according to another preferred embodiment of the presently disclosed subject matter;

FIG. 4 shows an example of an original image collected by a vehicle damage identification method according to a preferred embodiment of the presently disclosed subject matter;

FIG. 5 is a block diagram showing a schematic configuration of a vehicle damage identification apparatus according to a preferred embodiment of the presently disclosed subject matter;

FIG. 6 is a block diagram showing a schematic configuration of the damage identification modules of a vehicle damage identification apparatus according to a preferred embodiment of the presently disclosed subject matter;

FIG. 7 is a block diagram showing a schematic configuration of a vehicle damage identification apparatus according to another preferred embodiment of the presently disclosed subject matter;

FIG. 8 is a diagram of an exemplary system architecture to which an embodiment of the presently disclosed subject matter may be applied;

FIG. 9 is a schematic structural diagram of a computer system suitable for implementing a terminal device according to an embodiment of the presently disclosed subject matter; and

FIG. 10 shows an example of an operation flow of a terminal device for implementing an embodiment of the presently disclosed subject matter.

### DETAILED DESCRIPTION

The technical solution of the presently disclosed subject matter will be described clearly and completely in the following in conjunction with specific embodiments of the presently disclosed subject matter and the corresponding accompanying drawings. Apparently, the described embodiments are merely some preferred embodiments rather than all embodiments of the presently disclosed subject matter. Based on the embodiments of the presently disclosed subject matter, all other embodiments obtained by those of ordinary skill in the art without creative efforts shall fall within the protection scope of the presently disclosed subject matter.

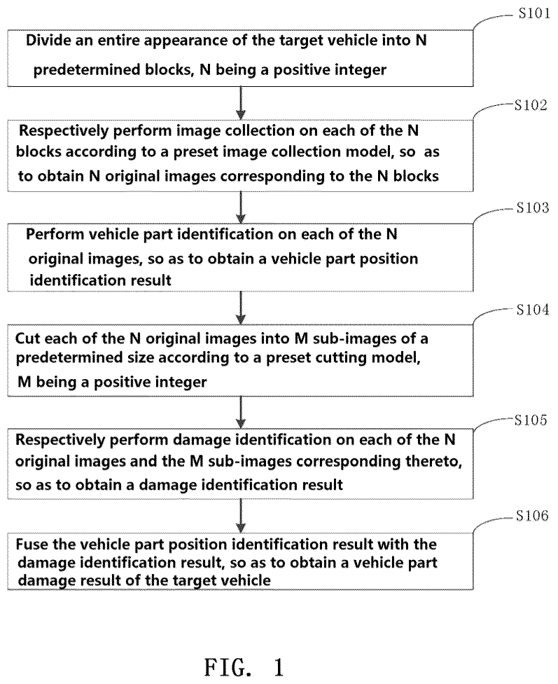

A vehicle damage identification method for identifying a damage of a target vehicle according to an embodiment of the presently disclosed subject matter will be described below in conjunction with FIGS. 1 to 3.

FIG. 1 is a schematic flowchart of a vehicle damage identification method according to a preferred embodiment of the presently disclosed subject matter. As shown in FIG. 1, the vehicle damage identification method according to the presently disclosed subject matter includes the following Steps S101 to S106, and each step will be described in detail below.

Step S101 is a division step.

The entire appearance of the target vehicle is divided into N predetermined blocks, N being a positive integer.

As an example, for example, the entire appearance of the target vehicle may be divided into 14 blocks, and the 14 blocks may include: a front side upper portion, a front side lower portion, a left front portion, a right front portion, a left side front portion, a right side front portion, a left side middle portion, a right side middle portion, a left side rear portion, a right side rear portion, a left rear portion, a right rear portion, a rear side upper portion, and a rear side lower portion of the target vehicle.

It needs to be pointed out that the above division method of the presently disclosed subject matter is only an example, and the appearance of the target vehicle may be reasonably divided into multiple regions by other division methods. In addition, the blocks adjacent to each other in the above 14 blocks may have portions overlapping with each other. In addition, Step S101 may be pre-performed prior to performing the vehicle damage identification method.

Step S102 is an original image collection step.

The image collection is respectively performed on each of the N blocks according to a preset image collection model, so as to obtain N original images corresponding to the N blocks.

Specifically, the image collection model includes: respectively performing image collection on the N blocks of the target vehicle at a preset shooting angle, so as to obtain the N original images with an aspect ratio of a:b.

For example, the shooting angle of a camera device may be controlled by a controller, so as to respectively perform image collection on the N regions of the target vehicle at a preset shooting angle. By controlling the camera device to perform image collection at a preset shooting angle, overlapping portions can be formed between adjacent blocks in the N blocks.

Regarding the preset shooting angle, for example, taking the above-mentioned 14 blocks as an example, the shooting angles corresponding to the 14 blocks will be described in detail below.

Front side upper portion: taking the left and right headlights on the front side and the lower edge of the front bumper of the target vehicle as the main alignment objects, shooting is carried out in front of the target vehicle. Specifically, for example, the left and right headlights on the front side may be positioned at the left and right side edges of the image, and the lower edge of the front bumper may be positioned at the lower side edge of the image.

Front side lower portion: taking the left and right headlights on the front side, the lower edge of the front bumper, and the roof of the target vehicle as the main alignment objects, shooting is carried out in front of the target vehicle. Specifically, for example, the left and right headlights on the front side may be positioned at the left and right side edges of the image, and the lower edge of the front bumper may be positioned at the approximate center of the image, and the roof may be positioned at the upper side edge of the image.

Left front portion: shooting is carried out at the left diagonal front of the target vehicle, so that the image takes the front bumper as the alignment standard, and the left side of the image includes the license plate and the right side includes the entire fender. For example, the front bumper may be located in an approximate middle position in the up-down direction in the left side of the image, and the left side of the image includes the license plate, and the right side includes the entire fender.

Right front portion: shooting is carried out at the right diagonal front of the target vehicle, so that the image takes the front bumper as the alignment standard, and the right side of the image includes the license plate and the left side includes the entire fender. For example, the front bumper may be located in an approximate middle position in the up-down direction in the right side of the image, and the right side of the image includes the license plate, and the left side includes the entire fender.

Left side front portion: shooting is carried out at the left front of the target vehicle, so that the left side of the image includes the left front headlight, and the right side of the image includes as much of the left body of the vehicle as possible in the shot (e.g., see FIG. 4).

Right side front portion: shooting is carried out at the right front of the target vehicle, so that the right side of the image includes the right front headlight, and the left side of the image includes as much of the right body of the vehicle as possible in the shot.

Left side middle portion: shooting is carried out at the left side of the target vehicle, so that the junction of the front and rear doors is located in the central position in the left-right direction of the image, the upper side of the image is aligned with the roof, and the left and right sides of the image include as much of the front and rear doors as possible in the shot.

Right side middle portion: shooting is carried out at the right side of the target vehicle, so that the junction of the front and rear doors is located in the central position in the left-right direction of the image, the upper side of the image is aligned with the roof, and the left and right sides of the image include as much of the front and rear doors as possible in the shot.

Left side rear portion: shooting is carried out at the left rear of the target vehicle, so that the right side of the image includes the left rear headlight, and the left side of the image includes as much of the left body of the vehicle as possible in the shot.

Right side rear portion: shooting is carried out at the right rear of the target vehicle, so that the left side of the image includes the right rear headlight, and the right side the image includes as much of the right body of the vehicle as possible in the shot.

Left rear portion: shooting is carried out at the left diagonal rear of the target vehicle, so that the image takes the rear bumper as the alignment standard, and the right side of the image includes the rear license plate and the left side includes the entire fender. For example, the rear bumper may be located in an approximate middle position in the up-down direction in the right side of the image, and the right side of the image includes the license plate, and the left side includes the entire fender.

Right rear portion: shooting is carried out at the right diagonal rear of the target vehicle, so that the image takes the rear bumper as the alignment standard, and the left side of the image includes the rear license plate and the right side includes the entire fender. For example, the rear bumper may be located in an approximate middle position in the up-down direction in the left side of the image, and the left side of the image includes the license plate, and the right side includes the entire fender.

Rear side upper portion: taking the left and right headlights on the rear side and the lower edge of the rear bumper of the target vehicle as the main alignment objects, shooting is carried out directly behind the target vehicle. Specifically, for example, the left and right headlights on the rear side may be positioned at the left and right side edges of the image, and the lower edge of the rear bumper may be positioned at the lower side edge of the image.

Rear side lower portion: taking the left and right headlights on the rear side, the lower edge of the rear bumper, and the roof of the target vehicle as the main alignment objects, shooting is carried out directly behind the target vehicle. Specifically, for example, the left and right headlights on the rear side may be positioned at the left and right side edges of the image, and the lower edge of the rear bumper may be positioned at the approximate center of the image, and the roof may be positioned at the upper side edge of the image.

Through the above standardized region division and the image collection, the parts in each region can repeatedly appear in multiple collected images, that is, there are overlapping portions between adjacent blocks in multiple blocks, so as to ensure that the damage can be detected in at least one or more images. Therefore, through the standardized division and image collection, it is possible to reduce the influence of subjective shooting of the user on the original image, improve the application efficiency of image collection, and improve the vehicle parts coverage rate of the vehicle in the image, thereby improving the efficiency of damage identification. It should be noted that the above vehicle parts used as the alignment standard are not limited to the above-described contents, and may be appropriately set as long as it can be ensured that the parts in each region repeatedly appear in multiple collected images, so that the damage can be detected in at least one or more images.

In addition, the image collection model may further include: performing image collection with a fixed pixel. For example, the image collection may be performed with the fixed pixel of 4032*3024 in a horizontal shooting mode. Thereby, an original image with a common aspect ratio of a:b=4:3 can be obtained.

It should be noted that the above angle, pixel, aspect ratio, etc. of the image collection are only an example, and can be appropriately set as required.

Step S103 is a vehicle part position identification step.

The vehicle part identification is performed on each of the N original images, so as to obtain a vehicle part position identification result.

Specifically, in this embodiment, based on the original images of each region that have been collected, vehicle part detection is performed on each original image by using a vehicle part detection model that has been pre-trained, so as to obtain a vehicle part position identification result corresponding to each original image. The vehicle part detection model includes a machine learning program, which includes, for example, a vehicle part detection AI system. The machine learning program is trained by sample data of a vehicle part image to identify vehicle parts in the image. The sample data of the vehicle part image is, for example, the initial image data stored in the database and containing vehicle parts, and is used to train the machine learning program.

Step S104 is an original image cutting step.

Each of the N original images is cut into M sub-images of a predetermined size according to a preset cutting model, M being a positive integer. Preferably, the sizes of the M sub-images are exactly the same.

Specifically, the cutting model may be implemented by using a cutting algorithm such as a sliding window and overlap=0. For example, in the case that the aspect ratio of the collected original image is a:b, an a-equal division is performed on the original image in a transverse direction and a b-equal division is performed on the original image in a longitudinal direction in each of the obtained N original images, so as to obtain a×b sub-images, wherein a×b=M.

As an example, referring to FIG. 4, the original image has a pixel of 4032*3024 and an aspect ratio of 4:3. For each original image, the above cutting model is set to overlap=0 and step=1008; a 4-equal division is performed on the original image in the transverse direction, and a 3-equal division is performed on the original image in the longitudinal direction, so as to obtain 12 square sub-images with a pixel of 1008*1008.

The size of the image on a training set for the object detection of the prior art is usually between 600 and 1000 (pixel). This is because the convolution network has a poor invariance implicit ability in size, rotation, and translation. Moreover, the object detection of the prior art speeds up the processing in order to batch the images, and thus the pre-processing of the image includes the processing of adjusting the size or cutting into squares.

In contrast, the above cutting method of the presently disclosed subject matter makes the size of the cut image basically conform to the size of the training image, which avoids problems that may be encountered in the above convolution, and there is no need to perform a size adjustment, etc., so that the aspect ratio of the image will not be changed, and then all original features of the whole original image are saved.

Step S105 is a damage identification step.

The damage identification is respectively performed on each of the N original images and the M sub-images corresponding thereto, so as to obtain a damage identification result.

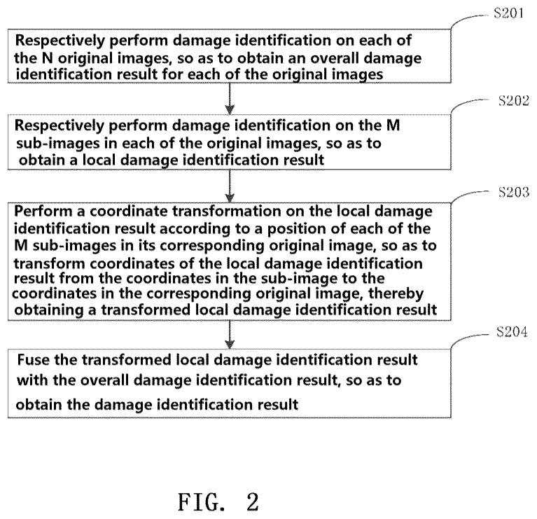

Specifically, as an example, the above Step S105 includes the following Steps S201 to S204. The above Steps S201 to S204 according to the embodiment of the presently disclosed subject matter will be described below with reference to FIG. 2.

S201 is an overall damage identification step.

The damage identification is respectively performed on each of the N original images, so as to obtain an overall damage identification result for each of the original images.

Specifically, for the original image that has been collected, it is inputted to a vehicle damage detection model that has been pre-trained, to perform the global damage identification on each original image, so as to obtain an overall damage identification result corresponding to each original image. The vehicle damage detection model includes a machine learning program, which includes, for example, a vehicle damage object detection AI system. The machine learning program is trained by sample data of a vehicle part damage image to identify vehicle damages in the image. The sample data of the vehicle part damage image is, for example, the initial image data stored in the database and containing damaged vehicle parts, and is used to train the machine learning program.

S202 is a local damage identification step.

The damage identification is respectively performed on the M sub-images in each of the original images, so as to obtain a local damage identification result.

Specifically, for the M sub-images into which each original image is divided, each sub-image is inputted to the above-mentioned vehicle damage detection model to perform local damage identification on each sub-image, so as to obtain a local damage identification result corresponding to each sub-image.

S203 is a coordinate transformation step.

The coordinate transformation is performed on the local damage identification result according to a position of each of the M sub-images in its corresponding original image, so as to transform coordinates of the local damage identification result from the coordinates in the sub-image to the coordinates in the corresponding original image, thereby obtaining a transformed local damage identification result.

Specifically, since the sub-images of the present application are images obtained by standardized cutting, an offset value may be calculated based on the position of each sub-image in its corresponding original image, so that the local coordinates of the local damage identification result in the sub-image are converted to the coordinates in the original image based on the offset value, thereby obtaining the converted local damage identification result.

S204 is a damage fusion step.

The transformed local damage identification result is fused with the overall damage identification result, so as to obtain the damage identification result.

Specifically, since the transformed local damage identification result has undergone coordinate transformation, it is in the same coordinate system as the overall damage identification result. Therefore, the two may be fused to obtain a damage identification result where the local damage identification and the overall damage identification are fused, corresponding to each original image. The damage identification result includes both the local damage identification and the overall damage identification in the same coordinate system.

The flow of the damage identification step is described above. With the above Steps S201 to S204, the damage identification can be performed on the original image and the sub-image respectively, thereby improving the precision and accuracy of the damage identification.

Step S106 is a vehicle part damage fusion step.

The vehicle part position identification result obtained in Step S103 is fused with the damage identification result obtained in Step S105, so as to obtain a vehicle part damage result of the target vehicle. That is, the vehicle part position identification result is correlated/matched with the damage identification result.

Specifically, in the prior art, the bounding box intersection over union ratio is generally used to perform coordinate matching.

In the presently disclosed subject matter, due to the characteristic that the damage box is small, the matching effect is poor if the above coordinate matching method is used. Therefore, the bounding box intersection over damage area ratio can be used to perform coordinate matching for the relative position between the vehicle damage and the vehicle part in the presently disclosed subject matter, so as to obtain a result of the vehicle damage. The bounding box intersection over damage area ratio is expressed by the following formula:

$$IOA = \frac{Area of Intersection}{Area of Damage} ,$$

where, IOA represents the bounding box intersection over damage area ratio; Area of Intersection represents the area of the intersection, that is, the area of the region where the two boxes, i.e., the damage box and the vehicle part box overlap; and Area of Damage represents the area of the damage box.

When the ratio of IOA is greater than a predetermined threshold (e.g., 50%), the coordinates of the intersection region of the damage box are correlated/matched with the vehicle part corresponding to the coordinates, so that the corresponding vehicle part is identified as a damaged vehicle part to generate a vehicle part damage result.

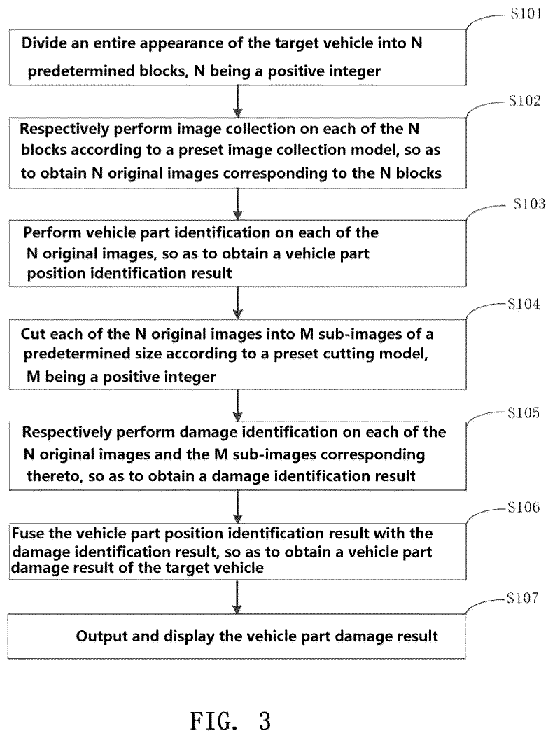

In addition, as shown in FIG. 3, the vehicle damage identification method according to the embodiment of the presently disclosed subject matter may further include Step S107: a result output step, that is, outputting and displaying the vehicle part damage result obtained by fusion.

The damage identification method according to an embodiment of the presently disclosed subject matter is described above. The embodiment of the presently disclosed subject matter further provides a vehicle damage identification system for performing damage identification on a target vehicle, and the system may include: a camera device, a controller and an image processor.

The controller controls the camera device to respectively perform image collection on N blocks of the target vehicle at a preset shooting angle, so as to generate the N original images with an aspect ratio of a:b, and transmits the generated N original images to the image processor for damage identification processing, wherein the N blocks are vehicle regions that have been pre-divided based on an entire appearance of the target vehicle, and N is a positive integer.

The image processor may perform the operations of Steps S103 to S107 above.

The vehicle damage identification method and system according to the presently disclosed subject matter is described above, and it utilizes a standardized image collection flow and an image pre-processing flow to convert the vehicle damage identification from a subjective judgment to a scientific and objective judgment, which reduces the user's reliance on vehicle professional knowledge, provides wide versatility and compatibility, and improves the identification efficiency of minor vehicle damage identification, and increases the AI identification speed while realizing the real AI intelligent loss assessment. Moreover, by using the standardized image collection flow and the image pre-processing flow, the number of times of image collection can be reduced and the image collection process can be sped up without affecting the accuracy of damage identification, thereby increasing the speed of the entire damage identification, reducing the manpower time required by damage identification (which may be reduced to be within 5 minutes), and thereby reducing the training cost of the personnel.

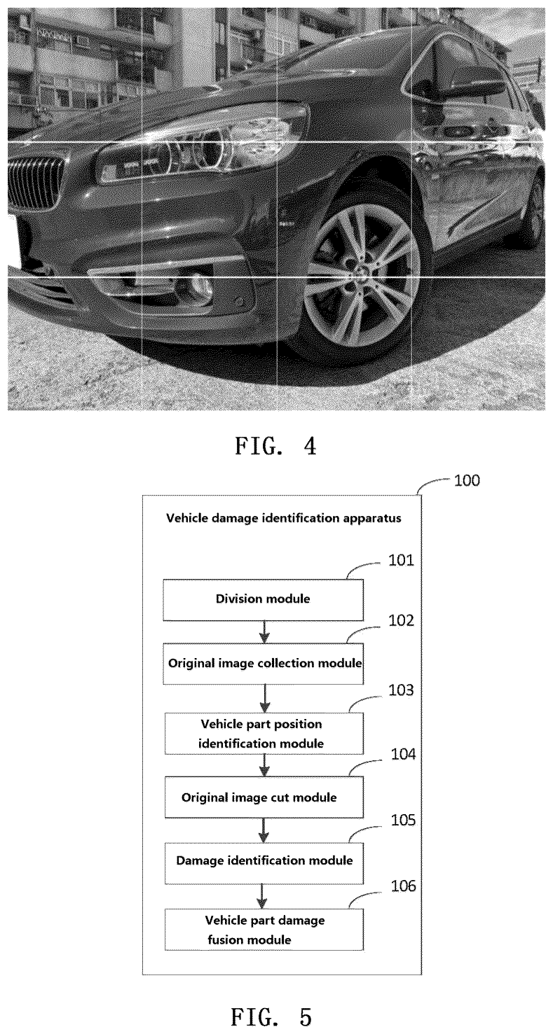

The damage identification method and system according to an embodiment of the presently disclosed subject matter is described above, and the embodiment of the presently disclosed subject matter further provides a damage identification apparatus. As shown in the figure, the damage identification apparatus 100 according to the embodiment of the presently disclosed subject matter includes modules 101 to 106. The damage identification apparatus 100 according to the embodiment of the presently disclosed subject matter will be described below with reference to FIG. 5.

Module 101 is a division module.

The division module 101 is configured to divide an entire appearance of the target vehicle into N predetermined blocks, N being a positive integer.

As an example, for example, the division module 101 may divide the entire appearance of the target vehicle into 14 blocks that may include: a front side upper portion, a front side lower portion, a left front portion, a right front portion, a left side front portion, a right side front portion, a left side middle portion, a right side middle portion, a left side rear portion, a right side rear portion, a left rear portion, a right rear portion, a rear side upper portion, and a rear side lower portion of the target vehicle.

It needs to be pointed out that the above division method of the presently disclosed subject matter is only an example, and the appearance of the target vehicle may be reasonably divided into multiple regions by other division methods. In addition, the blocks adjacent to each other in the above 14 blocks may have portions overlapping with each other.

Module 102 is an original image collection module.

The original image collection module 102 is configured to respectively perform image collection on each of the N blocks according to a preset image collection model, so as to obtain N original images corresponding to the N blocks.

Specifically, the image collection model includes: respectively performing image collection on N regions of the target vehicle at a preset shooting angle, so as to obtain the N original images with an aspect ratio of a:b.

Regarding the preset shooting angle, for example, taking the above-mentioned 14 blocks as an example, the shooting angles corresponding to the 14 blocks will be described in detail below.

Front side upper portion: taking the left and right headlights on the front side and the lower edge of the front bumper of the target vehicle as the main alignment objects, shooting is carried out in front of the target vehicle. Specifically, for example, the left and right headlights on the front side may be positioned at the left and right side edges of the image, and the lower edge of the front bumper may be positioned at the lower side edge of the image.

Front side lower portion: taking the left and right headlights on the front side, the lower edge of the front bumper, and the roof of the target vehicle as the main alignment objects, shooting is carried out in front of the target vehicle. Specifically, for example, the left and right headlights on the front side may be positioned at the left and right side edges of the image, and the lower edge of the front bumper may be positioned at the approximate center of the image, and the roof may be positioned at the upper side edge of the image.

Left front portion: shooting is carried out at the left diagonal front of the target vehicle, so that the image takes the front bumper as the alignment standard, and the left side of the image includes the license plate and the right side includes the entire fender. For example, the front bumper may be located in an approximate middle position in the up-down direction in the left side of the image, and the left side of the image includes the license plate, and the right side includes the entire fender.

Right front portion: shooting is carried out at the right diagonal front of the target vehicle, so that the image takes the front bumper as the alignment standard, and the right side of the image includes the license plate and the left side includes the entire fender. For example, the front bumper may be located in an approximate middle position in the up-down direction in the right side of the image, and the right side of the image includes the license plate, and the left side includes the entire fender.

Left side front portion: shooting is carried out at the left front of the target vehicle, so that the left side of the image includes the left front headlight, and the right side of the image includes as much of the left body of the vehicle as possible in the shot (e.g., see FIG. 4).

Right side front portion: shooting is carried out at the right front of the target vehicle, so that the right side of the image includes the right front headlight, and the left side of the image includes as much of the right body of the vehicle as possible in the shot.

Left side middle portion: shooting is carried out at the left side of the target vehicle, so that the junction of the front and rear doors is located in the central position in the left-right direction of the image, the upper side of the image is aligned with the roof, and the left and right sides of the image include as much of the front and rear doors as possible in the shot.

Right side middle portion: shooting is carried out at the right side of the target vehicle, so that the junction of the front and rear doors is located in the central position in the left-right direction of the image, the upper side of the image is aligned with the roof, and the left and right sides of the image include as much of the front and rear doors as possible in the shot.

Left side rear portion: shooting is carried out at the left rear of the target vehicle, so that the right side of the image includes the left rear headlight, and the left side of the image includes as much of the left body of the vehicle as possible in the shot.

Right side rear portion: shooting is carried out at the right rear of the target vehicle, so that the left side of the image includes the right rear headlight, and the right side the image includes as much of the right body of the vehicle as possible in the shot.

Left rear portion: shooting is carried out at the left diagonal rear of the target vehicle, so that the image takes the rear bumper as the alignment standard, and the right side of the image includes the rear license plate and the left side includes the entire fender. For example, the rear bumper may be located in an approximate middle position in the up-down direction in the right side of the image, and the right side of the image includes the license plate, and the left side includes the entire fender.

Right rear portion: shooting is carried out at the right diagonal rear of the target vehicle, so that the image takes the rear bumper as the alignment standard, and the left side of the image includes the rear license plate and the right side includes the entire fender. For example, the rear bumper may be located in an approximate middle position in the up-down direction in the left side of the image, and the left side of the image includes the license plate, and the right side includes the entire fender.

Rear side upper portion: taking the left and right headlights on the rear side and the lower edge of the rear bumper of the target vehicle as the main alignment objects, shooting is carried out directly behind the target vehicle. Specifically, for example, the left and right headlights on the rear side may be positioned at the left and right side edges of the image, and the lower edge of the rear bumper may be positioned at the lower side edge of the image.

Rear side lower portion: taking the left and right headlights on the rear side, the lower edge of the rear bumper, and the roof of the target vehicle as the main alignment objects, shooting is carried out directly behind the target vehicle. Specifically, for example, the left and right headlights on the rear side may be positioned at the left and right side edges of the image, and the lower edge of the rear bumper may be positioned at the approximate center of the image, and the roof may be positioned at the upper side edge of the image.

Through the above standardized region division and the image collection, the parts in each region can repeatedly appear in multiple collected images, so as to ensure that the damage can be detected in at least one or more images. Therefore, through the standardized division and image collection, it is possible to reduce the influence of subjective shooting of the user on the original image, improve the application efficiency of image collection, and improve the vehicle parts coverage rate of the vehicle in the image, thereby improving the efficiency of damage identification. It should be noted that the above vehicle parts used as the alignment standard are not limited to the above-described contents, and may be appropriately set as long as it can be ensured that the parts in each region repeatedly appear in multiple collected images, so that the damage can be detected in at least one or more images.

In addition, the image collection model may further include: performing image collection with a fixed pixel. For example, the image collection may be performed with the fixed pixel of 4032*3024 in a horizontal shooting mode. Thereby, an original image with a common aspect ratio of a:b=4:3 can be obtained.

It should be noted that the above angle, pixel, aspect ratio, etc. of the image collection are only an example, and can be appropriately set as required.

Module 103 is a vehicle part position identification module.

The vehicle part position identification module 103 is configured to perform vehicle part identification on each of the N original images, so as to obtain a vehicle part position identification result.

Specifically, in this embodiment, the vehicle part position identification module 103 performs vehicle part detection on each original image by using a vehicle part detection model that has been pre-trained based on the original images of each region that have been collected, so as to obtain a vehicle part position identification result corresponding to each original image.

Module 104 is an original image cutting module.

The original image cutting module 104 is configured to cut each of the N original images into M sub-images of a predetermined size according to a preset cutting model, M being a positive integer. Preferably, the sizes of the M sub-images are exactly the same.

Specifically, the cutting model may be implemented by using a cutting algorithm such as a sliding window and overlap=0. For example, in the case that the aspect ratio of the collected original image is a:b, an a-equal division is performed on the original image in a transverse direction and a b-equal division is performed on the original image in a longitudinal direction in each of the obtained N original images, so as to obtain a×b sub-images, wherein a×b=M.

As an example, referring to FIG. 4, the original image has a pixel of 4032*3024 and an aspect ratio of 4:3. For each original image, the above cutting model is set to overlap=0 and step=1008; a 4-equal division is performed on the original image in the transverse direction, and a 3-equal division is performed on the original image in the longitudinal direction, so as to obtain 12 square sub-images with a pixel of 1008*1008.

The size of the image on a training set for the object detection of the prior art is usually between 600 and 1000 (pixel), while the convolution network has a poor invariance implicit ability in size, rotation, and translation. Moreover, the object detection of the prior art accelerates the processing in order to batch the images, and thus the pre-processing of the image includes the processing of adjusting the size or cutting into squares.

In contrast, the above cutting method of the presently disclosed subject matter makes the size of the cut image basically conform to the size of the training image, which avoids problems that may be encountered in the above convolution, and there is no need to perform a size adjustment, etc., so that the aspect ratio of the image will not be changed, and then all original features of the whole original image are saved.

Module 105 is a damage identification module.

The damage identification module 105 is configured to respectively perform damage identification on each of the N original images and the M sub-images corresponding thereto, so as to obtain a damage identification result.

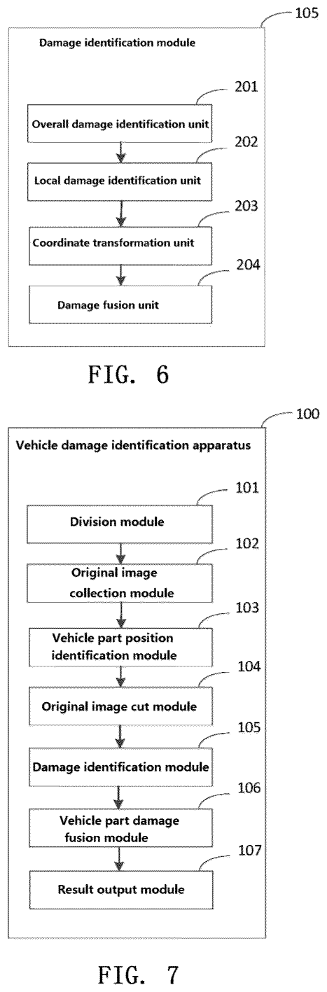

Specifically, as an example, the above module 105 includes the following units 201 to 204. The above units 201 to 204 according to the embodiment of the presently disclosed subject matter will be described below with reference to FIG. 6.

The unit 201 is an overall damage identification unit.

The overall damage identification unit 201 is configured to respectively perform damage identification on each of the N original images, so as to obtain an overall damage identification result for each of the original images.

Specifically, for the original image that has been collected, the overall damage identification unit 201 inputs it to a vehicle damage detection model (such as a vehicle damage object detection AI system) that has been pre-trained, to perform the global damage identification on each original image, so as to obtain an overall damage identification result corresponding to each original image.

The unit 202 is a local damage identification unit.

The local damage identification unit 202 is configured to respectively perform damage identification on the M sub-images in each of the original images, so as to obtain a local damage identification result.

Specifically, for the M sub-images into which each original image is divided, the local damage identification unit 202 inputs each sub-image to the above-mentioned vehicle damage detection model to perform local damage identification on each sub-image, so as to obtain a local damage identification result corresponding to each sub-image.

The unit 203 is a coordinate transformation unit.

The coordinate transformation unit 203 is configured to perform a coordinate transformation on the local damage identification result according to a position of each of the M sub-images in its corresponding original image, so as to transform coordinates of the local damage identification result from the coordinates in the sub-image to the coordinates in the corresponding original image, thereby obtaining a transformed local damage identification result.

Specifically, since the sub-images of the present application are images obtained by standardized cutting, the coordinate transformation unit 203 may calculate an offset value based on the position of each sub-image in its corresponding original image, so that the local coordinates of the local damage identification result in the sub-image are converted to the coordinates in the original image based on the offset value, thereby obtaining the converted local damage identification result.

The unit 204 is a damage fusion unit.

The damage fusion unit 204 is configured to fuse the transformed local damage identification result with the overall damage identification result, so as to obtain the damage identification result.

Specifically, since the transformed local damage identification result has undergone coordinate transformation, it is in the same coordinate system as the overall damage identification result. Therefore, the damage fusion unit 204 may fuse the two to obtain a damage identification result where the local damage identification and the overall damage identification are fused, corresponding to each original image.

Each unit of the damage identification module is described above. With the above units 201 to 204, the damage identification can be performed on the original image and the sub-image respectively, thereby improving the precision and accuracy of the damage identification.

Module 106 is a vehicle part damage fusion module.

The vehicle part position identification result obtained by the module 103 is fused with the damage identification result obtained by the module 105, so as to obtain a vehicle part damage result of the target vehicle.

Specifically, in the prior art, for coordinate matching of the relative position between the vehicle damage and the vehicle part, the bounding box intersection over union ratio is generally used to perform coordinate matching.

In the presently disclosed subject matter, due to the characteristic that the damage box is small, the matching effect is poor if the above coordinate matching method is used. Therefore, for example, the bounding box intersection over damage area ratio may be used to perform coordinate matching for the relative position between the vehicle damage and the vehicle part in the presently disclosed subject matter, so as to obtain a result of the vehicle damage. The bounding box intersection over damage area ratio is expressed by the following formula:

$$IOA = \frac{Area of Intersection}{Area of Damage}$$

where, IOA represents the bounding box intersection over damage area ratio; the area of the intersection is the area of the region where the two boxes, i.e., the damage box and the vehicle part box overlap; and the area of the damage is the area of the damage box.

In addition, as shown in FIG. 7, the vehicle damage identification apparatus according to the embodiment of the presently disclosed subject matter may further include module 107: a result output module. The result output module 107 is configured to output and display the vehicle part damage result obtained through fusion.

The vehicle damage identification apparatus according to the presently disclosed subject matter is described above, and it utilizes a standardized image collection flow and an image pre-processing flow to convert the vehicle damage identification from a subjective judgment to a scientific and objective judgment, which reduces the user's reliance on vehicle professional knowledge, provides wide versatility and compatibility, and improves the identification efficiency of minor vehicle damage identification, and increases the AI identification speed while realizing the real AI intelligent loss assessment. Moreover, by using the standardized image collection flow and the image pre-processing flow, the number of times of image collection can be reduced and the image collection process can be sped up without affecting the accuracy of damage identification, thereby increasing the speed of the entire damage identification, reducing the manpower time required by damage identification (which may be reduced to be within 5 minutes), and thereby reducing the training cost of the personnel.

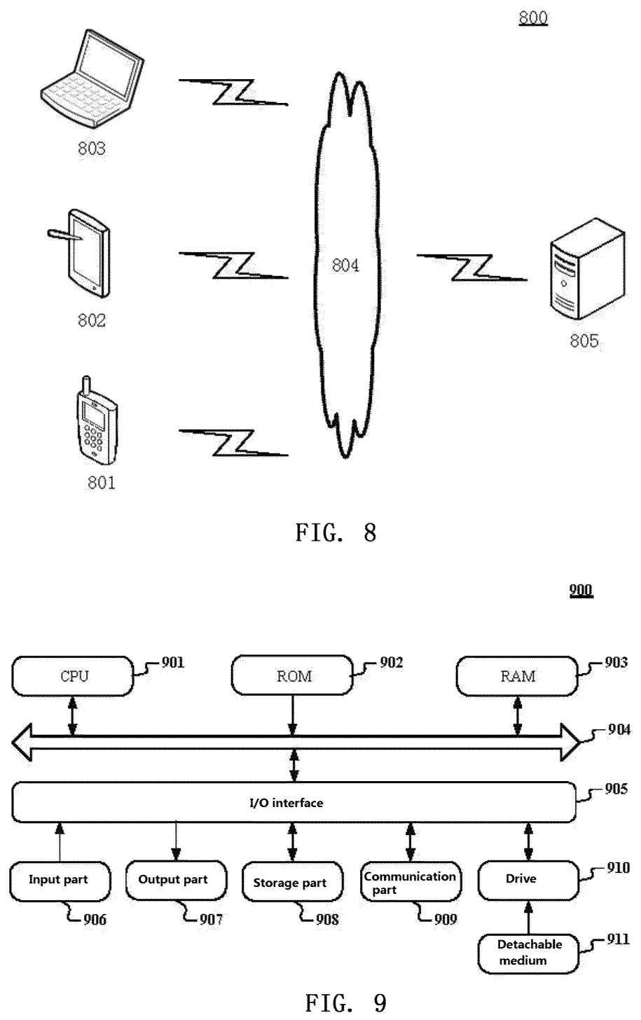

According to embodiments of the presently disclosed subject matter, there is provided a system architecture in which a vehicle damage identification method or a vehicle damage identification apparatus according to embodiments of the presently disclosed subject matter may be applied. FIG. 8 shows an exemplary system architecture 800 to which the vehicle damage identification method or vehicle damage identification apparatus according to embodiments of the presently disclosed subject matter may be applied.

As shown in FIG. 8, the system architecture 800 may include terminal devices 801, 802 and 803, a network 804, and a server 805 (this architecture is only an example, and the components included in the specific architecture may be adjusted according to specific conditions of the application). The network 804 is configured to provide a medium of a communication link between the terminal devices 801, 802 and 803 and the server 805. The network 804 may include various connection types, such as wired, wireless communication links or optical fiber cables, etc.

The user may use the terminal devices 801, 802 and 803 to interact with the server 805 through the network 804 to receive or send messages, etc. Various communication client applications may be installed on the terminal devices 801, 802 and 803, such as shopping applications, web browser applications, search applications, instant messaging tools, email clients, social platform software, etc. (examples only).

The terminal devices 801, 802 and 803 may be various electronic devices having display screens and supporting webpage browsing, including but not limited to smartphones, tablets, laptops, and desktop computers, etc.

The server 805 may be a server that provides various services, such as a background management server (only an example) that supports shopping websites browsed by users using terminal devices 801, 802 and 803. The background management server may perform analyzing and other processing on the received data such as a product information query request, and feed the processing results (such as target push information, product information-only examples) back to the terminal devices.

It should be noted that the vehicle damage identification method provided in the embodiment of the presently disclosed subject matter is generally executed by the terminal devices 801, 802 and 803, and accordingly, the vehicle damage identification device is generally provided in the terminal devices 801, 802 and 803.

It should be understood that the numbers of the terminal devices, networks and servers in FIG. 8 are merely schematic. According to implementation needs, there may be any number of terminal devices, networks, and servers.

Reference is made below to FIG. 9, which shows a schematic structural diagram of a computer system 900 suitable for implementing a terminal device according to an embodiment of the presently disclosed subject matter. The terminal device shown in FIG. 9 is merely an example and should not bring any limitation to the functions and use ranges of the embodiments of the presently disclosed subject matter.

As shown in FIG. 9, the computer system 900 includes a central processing unit (CPU) 901 that may perform various appropriate actions and processing according to programs stored in a read-only memory (ROM) 902 or programs loaded from a storage part 908 into a random access memory (RAM) 903. Various programs and data required by the operation of system 900 are also stored in RAM 903. CPU 901, ROM 902, and RAM 903 are connected to one another through bus 904. Input/output (I/O) interface 905 is also connected to bus 904.

The following components are connected to the I/O interface 905: an input part 906 including a keyboard, a mouse, etc.; an output part 907 including, for example, a cathode ray tube (CRT), a liquid crystal display (LCD), etc., and a speaker, etc.; a storage part 908 including a hard disk, etc.; and a communication part 909 including a network interface card such as a LAN card, a modem, etc. The communication part 909 performs communication processing via a network such as the Internet. A drive 910 is also connected to the I/O interface 905 as required. A detachable medium 911, such as a magnetic disk, an optical disk, a magneto-optical disk, a semiconductor memory, etc., is installed on the drive 910 as required so that the computer programs read therefrom can be installed into the storage part 908 as required.

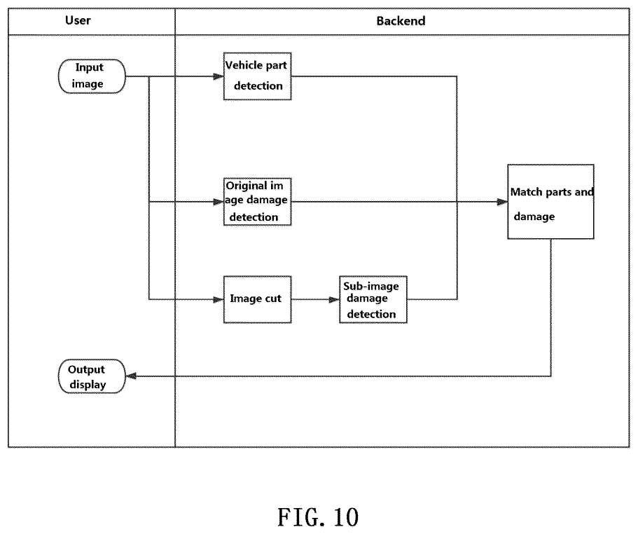

FIG. 10 shows an example of an operation flow of a terminal device for implementing an embodiment of the presently disclosed subject matter. The terminal devices may be the above-mentioned terminal devices 801, 802 and 803, etc. As shown in FIG. 10, in the presently disclosed subject matter, the terminal device at least includes a camera device for image collection and a display device for displaying, and in the backend (processor) of the terminal device, each step of the vehicle damage identification of the presently disclosed subject matter such as image processing and identification is performed.

According to the above terminal devices, an end-to-end standardized damage identification process can be realized, and the vehicle damage identification can be converted from the subjective judgment to the scientific and objective judgment, which reduces the user's reliance on vehicle professional knowledge, and can reduce the number of times of image collection and speed up the image collection process without affecting the accuracy of damage identification, thereby increasing the speed of the entire damage identification, reducing the manpower time required by damage identification (which may be reduced to be within 5 minutes), and thereby reducing the training cost of the personnel.

In particular, according to the embodiments disclosed in the presently disclosed subject matter, the process described above with reference to the flowchart may be implemented as a computer software program. For example, embodiments disclosed in the presently disclosed subject matter include a computer program product, which includes a computer program carried on a computer readable medium, and the computer program contains a program code for performing the method shown in the flowchart. In such embodiments, the computer program may be downloaded and installed from the network via the communication part 909, and/or installed from the detachable medium 911. When the computer program is executed by the central processing unit (CPU) 901, the above functions defined in the system of the presently disclosed subject matter are executed.

It should be noted that the computer readable medium shown in the presently disclosed subject matter may be a non-transitory computer-readable signal medium or a non-transitory computer-readable storage medium or any combination of the above two. The computer-readable storage medium may be, for example,—but is not limited to—an electrical, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the presently disclosed subject matter, the computer-readable storage medium may be any tangible medium that contains or stores a program that may be used by or in combination with an instruction execution system, apparatus, or device. Moreover, in the presently disclosed subject matter, the computer-readable signal medium may include a data signal propagated in a baseband or as part of a carrier, where a computer-readable program code is carried. Such a propagated data signal may take a variety of forms, including but not limited to an electromagnetic signal, an optical signal, or any suitable combination of the above. The computer-readable signal medium may also be any computer-readable medium other than a computer-readable storage medium, and the computer-readable medium may send, propagate, or transmit a program for use by or in conjunction with an instruction execution system, apparatus, or device. The program code contained on the computer-readable medium may be transmitted by any suitable medium, including but not limited to: wireless, wire, optical cable, RF, etc., or any suitable combination of the above.

The flowcharts and block diagrams in the accompanying drawings illustrate the system architectures, functions and operations that can be possibly implemented by the system, method and computer program product according to various embodiments of the presently disclosed subject matter. In this regard, each block in the flowcharts or block diagrams may represent a module, a program segment, or part of a code, and the above module, program segment, or part of a code includes one or more executable instructions for implementing specified logical functions. It should also be noted that in some alternative implementations, functions marked in the blocks may also occur in an order different from that marked in the accompanying drawings. For example, two blocks represented in succession may actually be executed in parallel, and sometimes they may also be executed in an inverse order, which depends on involved functions. It should also be noted that each block in the block diagrams or flowcharts as well as a combination of blocks in the block diagrams or flowcharts may be implemented using a special hardware-based system that executes specified functions or operations, or using a combination of special hardware and computer instructions.

The modules involved and described in the embodiments of the presently disclosed subject matter may be implemented in a software manner, and may also be implemented in a hardware manner. The described modules may also be set in a processor, for example, may be described as: a processor including a division module, an original image collection module, a vehicle part position identification module, an original image cutting module, a damage identification module, and a vehicle part damage fusion module. Among them, the names of these modules do not constitute a limitation on the modules themselves in some cases. For example, the original image collection module may also be described as “a shooting module for collecting the original image”.

As another aspect, the presently disclosed subject matter further provides a computer-readable medium, which may be contained in the devices described in the above embodiments, and may also exist alone, without being assembled into the devices. The above computer-readable medium carries one or more programs, and when the above one or more programs are executed by one of the devices, the device includes:
dividing an entire appearance of the target vehicle into N predetermined blocks, N being a positive integer;
respectively performing image collection on each of the N blocks according to a preset image collection model, so as to obtain N original images corresponding to the N blocks;
performing vehicle part identification on each of the N original images, so as to obtain a vehicle part position identification result;
cutting each of the N original images into M sub-images of a predetermined size according to a preset cutting model, M being a positive integer;
respectively performing damage identification on each of the N original images and the M sub-images corresponding thereto, so as to obtain a damage identification result; and
fusing the vehicle part position identification result with the damage identification result, so as to obtain a vehicle part damage result of the target vehicle.

The presently disclosed subject matter is suitable for the algorithm/model having an artificial neural network with a fixed size, which provides a vehicle damage identification method and system, an electronic device, and a storage medium. It utilizes an end-to-end standardized damage identification process to convert the vehicle damage identification from a subjective judgment to a scientific and objective judgment, which reduces the user's dependence on vehicle professional knowledge, provides wide versatility and compatibility, and improves the identification efficiency of minor vehicle damage identification. Moreover, by using a standardized image collection flow and an image pre-processing flow, the presently disclosed subject matter can reduce the number of times of image collection and speed up the image collection process without affecting the accuracy of damage identification, thereby increasing the speed of the entire damage identification and improving the efficiency of damage identification.

The above descriptions are merely embodiments of the present application and are not intended to limit the presently disclosed subject matter. For those skilled in the art, the presently disclosed subject matter may have various modifications and changes. Any modification, equivalent replacement, or improvement made without departing from the spirit and principle of the presently disclosed subject matter shall fall within the scope of the claims of the presently disclosed subject matter.

The invention claimed is:

1. A vehicle damage identification method for performing damage identification on a target vehicle, wherein the method comprises:
respectively performing image collection on N blocks of the target vehicle at a preset shooting angle by using a camera device, so as to generate N original images with an aspect ratio of a:b, wherein the N blocks are vehicle regions pre-divided based on an entire appearance of the target vehicle, and N is a positive integer;
performing vehicle part identification on each of the N original images by using a vehicle part detection model, so as to obtain a vehicle part position identification result, the vehicle part detection model comprising a machine learning program, the machine learning program being trained by sample data of a vehicle part image to identify vehicle parts in the image;
processing the N original images, so as to cut each of the N original images into M sub-images of a predetermined size, M being a positive integer;
respectively performing damage identification on each of the N original images and the M sub-images corresponding thereto by using a vehicle damage detection model, so as to obtain a damage identification result, the vehicle damage detection model comprising a machine learning program, the machine learning program being trained by sample data of a vehicle part damage image to identify vehicle damages in the image; and
correlating the vehicle part position identification result with the damage identification result, so as to output a vehicle part damage result of the target vehicle.

2. The method according to claim 1, wherein processing the N original images, so as to cut each of the N original images into M sub-images of a predetermined size comprises:
performing an a-equal division on the original image in a transverse direction and performing a b-equal division on the original image in a longitudinal direction in each of the N original images, so as to obtain a×b sub-images,
wherein a×b=M.

3. The method according to claim 1, wherein respectively performing damage identification on each of the N original images and the M sub-images corresponding thereto based on the vehicle damage detection model, so as to obtain a damage identification result comprises:
respectively performing damage identification on each of the N original images based on the vehicle damage detection model, so as to obtain an overall damage identification result for each of the original images;
respectively performing damage identification on the M sub-images in each of the original images based on the vehicle damage detection model, so as to obtain a local damage identification result;
performing a coordinate transformation on the local damage identification result according to a position of each of the M sub-images in its corresponding original image, so as to transform coordinates of the local damage identification result from the coordinates in the sub-image to the coordinates in the corresponding original image, thereby obtaining a transformed local damage identification result; and
fusing the transformed local damage identification result with the overall damage identification result, so as to obtain the damage identification result.

4. The method according to claim 3, wherein the N blocks comprise 14 blocks, the 14 blocks comprising:
a front side upper portion, a front side lower portion, a left front portion, a right front portion, a left side front portion, a right side front portion, a left side middle portion, a right side middle portion, a left side rear portion, a right side rear portion, a left rear portion, a right rear portion, a rear side upper portion, and a rear side lower portion of the target vehicle.

5. A vehicle damage identification system for performing damage identification on a target vehicle, wherein the system comprises: a camera device, a controller and an image processor, wherein
the controller controls the camera device to respectively perform image collection on N blocks of the target vehicle at a preset shooting angle, so as to generate N original images with an aspect ratio of a:b, and transmits the generated N original images to the image processor for damage identification processing, wherein the N blocks are vehicle regions pre-divided based on an entire appearance of the target vehicle, and N is a positive integer;
the image processor performs the following operations:
performing vehicle part identification on each of the N original images by using a vehicle part detection model, so as to obtain a vehicle part position identification result, the vehicle part detection model comprising a machine learning program, the machine learning program being trained by sample data of a vehicle part image to identify vehicle parts in the image;
processing the N original images, so as to cut each of the N original images into M sub-images of a predetermined size, M being a positive integer;
respectively performing damage identification on each of the N original images and the M sub-images corresponding thereto by using a vehicle damage detection model, so as to obtain a damage identification result, the vehicle damage detection model comprising a machine learning program, the machine learning program being trained by sample data of a vehicle part damage image to identify vehicle damages in the image; and
correlating the vehicle part position identification result with the damage identification result, so as to output a vehicle part damage result of the target vehicle.

6. The system according to claim 5, wherein the image processor performs an a-equal division on the original image in a transverse direction and performs a b-equal division on the original image in a longitudinal direction in each of the N original images, so as to obtain a×b sub-images,
wherein a×b=M.

7. The system according to claim 5, wherein the image processor
respectively performs damage identification on each of the N original images based on the vehicle damage detection model, so as to obtain an overall damage identification result for each of the original images;
respectively performs damage identification on the M sub-images in each of the original images based on the vehicle damage detection model, so as to obtain a local damage identification result;
performs a coordinate transformation on the local damage identification result according to a position of each of the M sub-images in its corresponding original image, so as to transform coordinates of the local damage identification result from the coordinates in the sub-image to the coordinates in the corresponding original image, thereby obtaining a transformed local damage identification result; and
fuses the transformed local damage identification result with the overall damage identification result, so as to obtain the damage identification result.

8. The system according to claim 7, wherein the N blocks comprise 14 blocks, the 14 blocks comprising:
a front side upper portion, a front side lower portion, a left front portion, a right front portion, a left side front portion, a right side front portion, a left side middle portion, a right side middle portion, a left side rear portion, a right side rear portion, a left rear portion, a right rear portion, a rear side upper portion, and a rear side lower portion of the target vehicle.

9. An electronic device, wherein the electronic device comprises:
a memory that stores a computer program;
a processor that executes the computer program to implement steps of the method according to claim 1; and
a camera device for performing image collection.

10. An electronic device, wherein the electronic device comprises:
a memory that stores a computer program;
a processor that executes the computer program to implement steps of the method according to claim 2; and
a camera device for performing image collection.

11. An electronic device, wherein the electronic device comprises:
a memory that stores a computer program;
a processor that executes the computer program to implement steps of the method according to claim 3; and
a camera device for performing image collection.

12. An electronic device, wherein the electronic device comprises:
a memory that stores a computer program;
a processor that executes the computer program to implement steps of the method according to claim 4; and
a camera device for performing image collection.

13. A non-transitory computer-readable storage medium, wherein a computer program is stored in the medium, and the computer program, when executed by a processor, implements steps of the method according to claim 1.

14. A non-transitory computer-readable storage medium, wherein a computer program is stored in the medium, and the computer program, when executed by a processor, implements steps of the method according to claim 2.

15. A non-transitory computer-readable storage medium, wherein a computer program is stored in the medium, and the computer program, when executed by a processor, implements steps of the method according to claim 3.

16. A non-transitory computer-readable storage medium, wherein a computer program is stored in the medium, and the computer program, when executed by a processor, implements steps of the method according to claim 4.
